(19) United States
(12) Patent Application Publication
(10) Pub. No.: US 2025/0241488 A1
(43) Pub. Date: Jul. 31, 2025

(54) A KITCHEN APPLIANCE

(71) Applicant: KENWOOD LIMITED, Havant, Hampshire (GB)

(72) Inventors: Luke MATTHEWS, Havant (GB); Sam DAVIES, Havant (GB)

(21) Appl. No.: 18/856,674

(22) PCT Filed: May 23, 2023
(86) PCT No.: PCT/GB2023/051345

§ 371 Date: Oct. 14, 2024

(30) Foreign Application Priority Data
Jun. 30, 2022 (GB) 2209627.5
Jul. 1, 2022 (LU) LU102974

(51) Int. Cl. A47J 43/07; A47J 43/044

(52) U.S. Cl. CPC A47J 43/07; A47J 43/044; A47J 2043/0738; A47J 2043/0744

(57) ABSTRACT

A kitchen appliance is disclosed having a main housing, a handle extending from the housing, and a storage space co-operatively defined between the handle and the housing. At least one accessory is provided, wherein the storage space includes one or more storage niches configured to releasably receive and secure the accessory of the kitchen appliance.

### FIELD

The present invention relates to a kitchen appliance, particularly to a kitchen appliance having enhanced tool or accessory storage. The present invention also extends to a kitchen appliance including a removably attachable scoop, and a kitchen appliance including a cable wrap.

### BACKGROUND

Kitchen appliances are typically provided with attachments and/or accessories (such as for example a plug, transformer, adapter, food processing tool, etc.) which may be used with them. Consumers often mislay these attachments/accessories so that they can no longer use them with the appliance. Additionally, these attachments/accessories take up additional space.

The solution of the applicant's patent publication no. GB2345650A is to provide an intermediate member to which attachments, such as whisks may be attached to the appliance. This helps keep the whisks together with the appliance thus making it less likely that they will be lost. However, it is not a space-efficient configuration and can result in the whisks or the intermediate member they are attached to being knocked off or lost.

The present invention aims to at least partially ameliorate the above-described problems of the prior art.

### SUMMARY OF THE INVENTION

According to an aspect of the present invention, there is provided a kitchen appliance comprising: a main housing, a handle extending for the main housing, and a storage space defined between the main housing and the handle, for example, for storing an accessory of the kitchen appliance. This can allow the kitchen appliance and its accessories to be stored in a compact and space-efficient configuration and also can remove the possibility that the accessories could be knocked off or lost.

Preferably, the kitchen appliance further comprises one or more accessories, such as food processing tools and/or a plug for the kitchen appliance. The one or more accessories may be stored in the storage space.

Preferably, the storage space comprises at least one storage hole, more preferably a blind hole or a recess. In some embodiments the at least one storage hole is a storage niche.

Preferably, each storage hole is configured to releasably receive and secure at least one of the one or more accessories of the kitchen appliance.

Preferably, the at least one accessory is releasably attachable to the kitchen appliance at a location other than within the storage space, such as a drive-outlet of the kitchen appliance. The at least one accessory may be a food processing tool.

Preferably, each accessory comprises a keyed attachment feature or a key-element that is matingly (or co-operatively) received within the at least one storage hole. Optionally, the keyed attachment feature is configured to act as a driving feature.

Preferably, each storage hole comprises a means configured to inhibit rotation of the at least one accessory received within each storage hole, for example, with a block abutting the keyed attachment feature.

Preferably, there are at least two accessories, and the anti-rotation means preferably orientates the accessories such that the accessories can be positioned within the storage space to be closer together than other orientations of the accessories, thereby enhancing storage.

Preferably, the storage space has an open end and a closed end, wherein the open end is opposite to the closed end of the storage space, allowing for enhanced access to the storage space. In some embodiments, the at least one storage hole is disposed on the closed end of the storage space.

Preferably, there are at least two accessories, and one of the two or more accessories is releasably secured within the storage hole and retains another of the two or more accessories within the storage space.

Preferably, there are at least two accessories, and the accessories are configured to co-operatively secure a plug of the kitchen appliance when the accessories are stored in the storage holes.

Preferably, the kitchen appliance further comprises an accessory ejector button/tool-ejector switch configured to eject the at least one accessory from the at least one storage hole. Optionally, the ejector button can be further configured to also eject the at least one accessory from the drive-outlet.

Preferably, the kitchen appliance further comprises a cover and the main housing comprises a base, and the cover is configured to enclose at least a portion of the kitchen appliance, preferably the storage space and/or a control button or one or more controls/a motor-control switch of the kitchen appliance, such that the cover forms a smooth continuous surface with the base, and the cover is removably attachable to the main housing.

This feature is also provided independently. Hence according to another aspect of the invention, there is provided a kitchen appliance comprising a main housing and a cover, wherein the main housing further comprises a base and the cover is configured to enclose at least a portion of the kitchen appliance, preferably a control button or one or more controls/a motor-control switch of the kitchen appliance, such that the cover forms a smooth continuous surface with the base, and the cover is removably attachable to the main housing.

Preferably, the cover comprises a handle and the cover is configured to render the kitchen appliance hand-carriable via the handle when attached to the main housing.

Preferably, the kitchen appliance further comprises a scoop, wherein at least one of:
the scoop is removably attachable to the main housing of the kitchen appliance, and the scoop is configured to retain an additional element, preferably a cable, on the main housing when attached to the main housing;
the scoop is configured to act as a removeable support for the kitchen appliance; and
the kitchen appliance further comprises a motor unit, wherein the scoop is removably attachable to the main housing such that the scoop and the main housing co-operatively enclose the motor unit.

This feature is also provided independently. Hence according to another aspect of the invention, there is provided a kitchen appliance comprising a scoop, wherein at least one of:
the scoop is removably attachable to a main housing of the kitchen appliance, and the scoop is configured to retain an additional element, preferably a cable, on the main housing when attached to the main housing;
the scoop is configured to act as a removeable support for the kitchen appliance; and
the kitchen appliance further comprises a main housing and a motor unit, wherein the scoop is removably attachable to the main housing, such that the scoop and the housing co-operatively enclose the motor unit.

The scoop preferably includes commonly used measurements in cooking such as a teaspoon, half a teaspoon, a table spoon etc. Attaching the scoop to the kitchen appliance will give the user quick and convenient access to the scoop.

Preferably, the scoop comprises a scoop portion and a handle portion. Optionally, the scoop portion is rounded, and the handle portion of the scoop retains the additional element.

Preferably, the scoop is attached to the main housing such that the scoop and the main housing co-operatively form a smooth continuous surface.

Preferably, the handle portion is concealed within the main housing.

According to another aspect of the invention, there is provided a kitchen appliance comprising a cable and a cable wrap recess/cable wrap niche. The cable wrap recess extends circumferentially around, preferably approximately a major axis and/or a widest part of, the kitchen appliance, preferably approximately parallel to the surface on which the kitchen appliance is to be placed, and is configured to receive the cable. This aspect can allow the cable to be neatly wrapped around the kitchen appliance, preventing possible damage that may occur to a loose cable. The cable recess can also provide a large surface for the venting required for the motor air intake/output.

Preferably, the cable wrap recess comprises one or more air inlets and one or more air outlets allowing for the ingress and egress of cooling air. The one or more air inlets and air outlets can be disposed on opposing ends of approximately the major axis of the kitchen appliance.

In another aspect of the invention, there is provided a kitchen appliance comprising a main housing, a storage space, and at least one accessory, wherein the storage space is configured to store the at least one accessory such that the at least one accessory does not exceed a footprint of the kitchen appliance.

Preferably, the kitchen appliance further comprises a cover, and the main housing comprises a base. The cover is configured to be removably attachable to the main housing and to enclose at least a portion of the kitchen appliance such that the cover forms a smooth continuous surface with the base. The cover comprises a handle and is further configured to render the kitchen appliance hand-carriable via the handle when attached to the main housing

As used herein, the term “major axis” as applied to the kitchen appliance preferably connotes a longer/wider axis of the kitchen appliance, rather than a shorter axis.

As used herein the term “footprint” as applied to the kitchen appliance preferably connotes the maximum extent of the kitchen appliance in plan view, rather than just the extent of the part of the kitchen appliance that sits on a surface that the kitchen appliance is placed upon.

Any apparatus feature as described herein may also be provided as a method feature, and vice versa. As used herein, means plus function features may be expressed alternatively in terms of their corresponding structure, such as a suitably programmed processor and associated memory.

The invention extends to methods, system and apparatus substantially as herein described and/or as illustrated with reference to the accompanying figures.

The invention extends to any novel aspects or features described and/or illustrated herein.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

In this specification the word ‘or’ can be interpreted in the exclusive or inclusive sense unless stated otherwise.

Furthermore, features implemented in hardware may generally be implemented in software, and vice versa. Any reference to software and hardware features herein should be construed accordingly.

The invention described here may be used in any appliance, such as a kitchen appliance, and/or as a stand-alone device. This includes any domestic food-processing and/or preparation appliance, including both top-driven appliances (e.g., stand-mixers) and bottom-driven appliances (e.g., food processors). It may be implemented in heated and/or cooled appliances. The invention may also be implemented in both hand-held (e.g., hand blenders) and table-top (e.g., blenders) appliances. It may be used in an appliance that is built-in to a work-top or work surface, or in a stand-alone device. The invention can also be provided as a stand-alone device, whether motor-driven or manually powered.

Whilst the invention has been described in the field of domestic food processing and preparation machines, it can also be implemented in any field of use where efficient, effective and convenient preparation and/or processing of material is desired, either on an industrial scale and/or in small amounts. The field of use includes the preparation and/or processing of: chemicals; pharmaceuticals; paints; building materials; clothing materials; agricultural and/or veterinary feeds and/or treatments, including fertilisers, grain and other agricultural and/or veterinary products; oils; fuels; dyes; cosmetics; plastics; tars; finishes; waxes; varnishes; beverages; solders; alloys; effluent; and/or other substances. Any reference to “food”, “beverage” (or similar language) herein may be replaced by such working mediums.

“Food processing” as described herein should be taken to encompass chopping, whisking, stirring, kneading, mincing, grinding, shaping, shredding, grating, cooking, freezing, making ice-cream, juicing (centrifugally or with a scroll), or other food-processing activities involving the physical and/or chemical transformation of food and/or beverage material by mechanical, chemical, and/or thermal means. “Food processing attachment” encompasses any attachable component configured, for example on rotation and/or energising, to carry out any of the previously described food processing tasks.

### BRIEF DESCRIPTION OF DRAWINGS

One or more aspects will now be described, by way of example only and with reference to the accompanying drawings having like-reference numerals, in which:

FIG. 1 shows a side-on view of a kitchen appliance according to the present invention;

FIG. 2 shows a side-on view of the kitchen appliance of FIG. 1 with its cover separated from the main body;

FIG. 3 shows a rear-on view of an alternative version of the kitchen appliance of FIG. 1, having a different lower motor-section shape, with the cover removed; and,

FIG. 4 shows a perspective view of the appliance of FIG. 3 with its cover removed and an alternative plug used.

### SPECIFIC DESCRIPTION

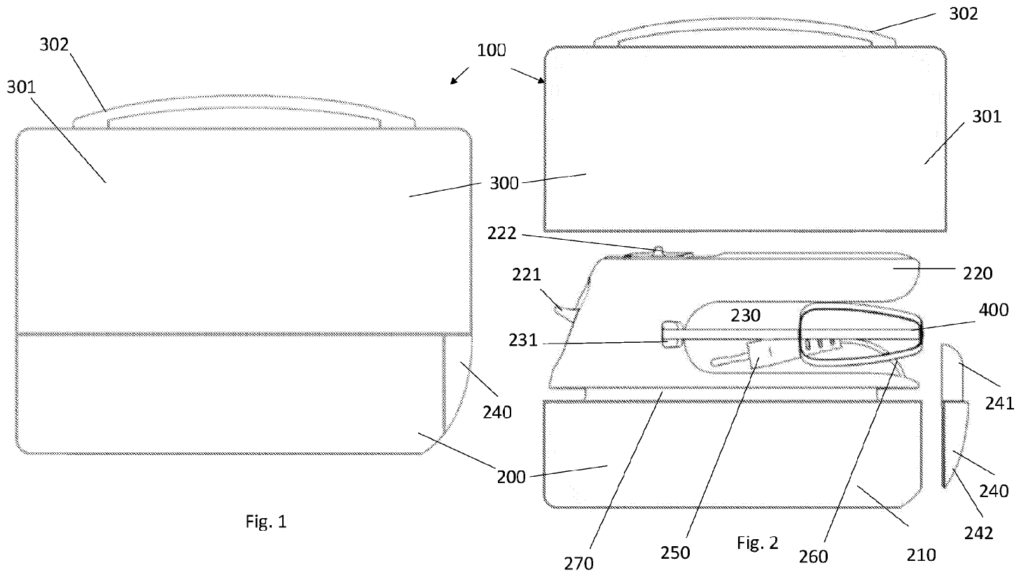

FIGS. 1 and 2 show a kitchen appliance 100, in this case a hand-mixer, having a main housing or a motor-housing 200 housing a motor (not shown) with a lower motor-section 210 and a generally “L”-shaped upper handle-section 220 extending firstly upwardly and away from an end of the motor-section 210 and then parallel to an exterior surface of the motor-section 210. The extension of the handle-section 220 parallel to the motor-section 210 defines a space 230 between them that is closed at one end by the handle-section 220. Tool-storage niches 231 are provided on the handle-section 220 facing towards the space 230, such that tools 400 (e.g., whisks, beaters, dough-hooks etc.) can be inserted into the tool-storage niches 231 through the space 230 so as to be releasably received in the tool-storage niches 231 extending into the space 230. A plug 250 for attachment to an external power supply (not shown) that delivers power to the motor of the kitchen appliance 100 through a cable 260 may also be located into the space 230 for storage therein. A clip (not shown) may be provided within the space 230 to retain the plug 250 therein. The use of the space 230 to provide storage space for tools 400 and plugs 250 provides a particularly space-efficient configuration.

A tool-ejector switch 221 is provided on the handle-section 220 whereby tools 400 connected to the motor-section 210 to receive drive therefrom may be ejected from the motor-section 210 by actuation of the switch 221. The tool-ejector switch 221 may also optionally act to eject tools 400 located within the tool-storage niches 231. A motor-control switch 222 is also provided on the handle-section 220 to control the motor of the kitchen appliance 100. The motor-control switch 222 may be a sliding or pivoting switch, and may act only to switch the motor on and off, or may also control the speed of the motor.

A cable-storage niche 270 extends around the motor-housing 200 along the surface of the major axis of the motor-section 210. The extension of the cable-storage niche 270 along the major axis of the motor-housing 200 means that the cable 260 may be wrapped around the motor-housing 200 so as to be thinly spread compared to being wrapped around a shorter axis, meaning that the cable-storage niche 270 can be shallower.

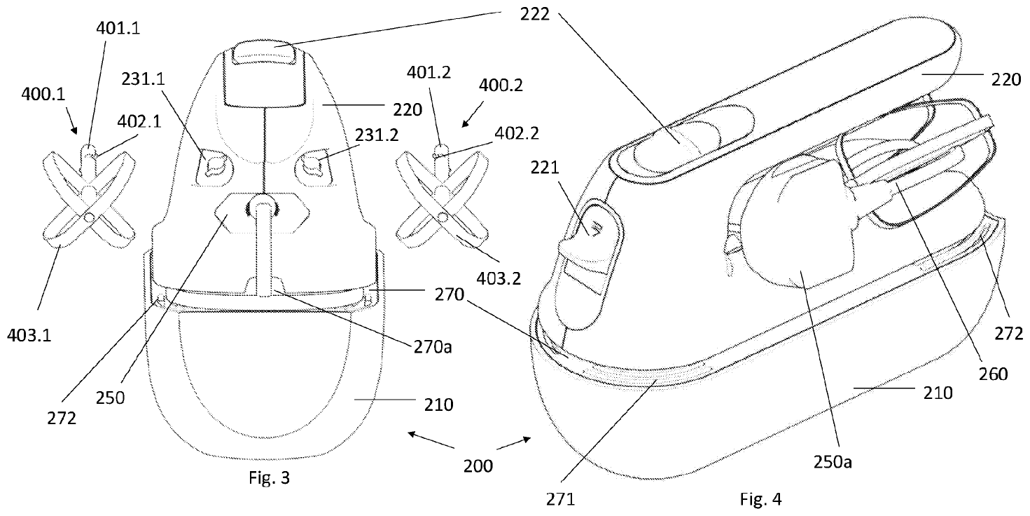

As can be seen in FIG. 3 (which shows an appliance with a slightly differently shaped lower portion), the cable-storage niche 270 is connected to the space 230 by a connecting niche 270a such that the cable 260 need not extend outside the cable storage niche 270 and space 230 in the storage configuration. As is shown in both FIGS. 3 and 4 air-intakes 271 and air-outlets 272 are provided within the cable-storage niche 270 at opposing ends of the appliance 100 so as to allow cooling air to enter and leave the motor-housing 200 to cool the motor. Locating the inlets 271 and outlets 272 at opposing ends of the appliance 100, with the body of the appliance 100 between them, helps avoid the mixing of cool inlet air with warmer outlet air. This is particularly the case when the inlets 271 and outlets 272 are located at opposing ends of the major axis of the appliance 100. Providing the air inlets 271 and outlets 272 within the cable-storage niche has the advantage of decreasing the likelihood of detritus entering the appliance 100 through them. This effect is enhanced by having the inlets 271 and outlets 272 provided facing the opposite side of the cable-storage niche 270 rather than towards the outside of the appliance 100.

The motor-housing 200 is shown partially covered in FIG. 1 by a removably-attachable cover 300. The cover 300 attaches to the motor-housing by, for example, resiliently clipping into the cable-storage niche 270 with, for example, resiliently-retractably protrusions. The cover 300 comprises a hollow portion 301 that is essentially a hollow box open on one side such that it can be placed over the motor-housing 200 so as to cover it on five sides, with one side left uncovered. A handle 302 is provided on an upper surface of the cover 300 to allow hand-carrying of the whole appliance 100 when the cover 300 is assembled thereto. When attached to the motor-housing 200, the cover 300 surrounds the space 230 co-operatively with the motor-section 210 so as to further secure the tools 400 and plug 250 within the space 230. The cover 300 also surrounds the cable-storage niche 270 so as to help retain the cable 260 therein. The cover 300 also covers the tool-ejector switch 221 and motor-control switch 222 when attached to the motor-housing 200, so as to help prevent accidental actuation of these switches in the storage configuration.

As can be seen in FIGS. 1 and 2, a scoop 240 is provided so as to be removably-attachable to the motor-section 210 and/or cover 300. The scoop 240 may extend so as to cover the cable-storage niche 270 and help retain the cable therein when attached to the appliance 100. The scoop 240 has a handle 241 and a shovel-shaped scoop-section 242. The scoop 240 may clip to the motor-housing 200 by resiliently clipping the handle 241 within the connecting niche 270a. The scoop-section 242 extends below the cover 300 when the cover 300 is assembled to the motor-housing 200 such that it forms a continuous and smooth surface external surface of the appliance 100 together with the cover 300 and motor-housing 200. Additionally, the scoop-section 242 can support the appliance 100 when it is placed at an orientation such that the scoop-section 242 contacts the surface on which the appliance 100 is placed. The scoop-section 242 may optionally extend all the way to the bottom of the appliance 100 when it is placed with the bottom resting on a surface to support the appliance 100. A hole (not shown) may be provided in the cover 300 may be provided for the cable 260 to be fed through if the user wishes to keep the appliance 100 plugged in when the cover 300 is attached.

As can be seen in FIG. 3, the tool-storage niches 231 have keyed apertures 231.1 and 231.2 which are shaped similarly to a key-hole so as to received correspondingly-shaped key-elements 402.1 and 402.2 located on the shafts 401.1 and 401.2 of the tools 400.1 and 400.2. In this case the key-elements 402.1 and 402.2 are essentially flanges extending from the shafts 401.1 and 401.2 that also double as driving-features of the tools 400.1 and 400.2 when they are located within the drive-outlets of the appliance 100 (not shown). The inter-engagement of the key-elements 402.1 and 402.2 with the apertures 231.1 and 231.2 helps locate the tools 400.1 and 400.2 within the space 230. The key-elements 402.1 and 402.2 may be retained within the keyed apertures 231.1 and 231.2 by resilient elements (e.g., leaf-springs) and/or by rotating the key-elements 402.1 and 402.2 so as to be blocked within the apertures 231.1 and 231.2 by blocks that partially cover the apertures 231.1 and 231.2. For particular convenience the key-elements 402.1 and 402.2 can be provided at or relatively close to an opposing end of their respective shafts 401.1 and 401.2 to tool-elements 403.1 and 403.2 which can perform work on food (e.g., whisking) when the tools 400.1 and 400.2 are rotated by the motor. In this way the tools 400.1 and 400.2 are held with their (typically larger, more easily gripped) tool-elements 403.1 and 403.2 extending away from the tool-storage niches 231 which face towards an open end of the space 230 for ease of insertion/removal, and into the space 230 for better utilisation of space.

Whilst the number of tools 400 shown in FIG. 3 is two, one or more tools 400 may be provided with corresponding tool-storage niches 31 to store them in within the space 230. With one tool 400 located in its corresponding tool-storage niche 31 and additional accessory (e.g., the plug 250) may be held within the space 230 between the tool 400 and the appliance 100. However, having at least two tools 400 within the space 230 allows accessories to be secured between them (e.g., the plug 250) with increased security.

Preferably rotation of the tools 400.1 and 400.2 the tool storage niches 231.1 and 231.2 is inhibited (e.g., with a block abutting the key-elements 402.1 and 402.2) once they are secured therein to enhance the effect of storing objects between them. Preventing rotation of the tools 400 also may help prevent injury (e.g., with a bladed attachment) and is thus advantageous regardless of their number. Preventing rotation can also encourage the user to orient the tools 400.1 and 400.2 at an orientation that facilitates the tools being closer together for more compact storage. For example the tools 400.1 and 400.2 may only be attachable at an angle where their tool-elements 403.1 and 403.2 do not extend directly towards each other, but instead extend at an angle that allows the shafts 401.1. and 401.2 to be located closer together, or even intermeshes/overlaps the tool-elements 403.1 and 403.2 for even more compact storage.

FIG. 4 shows a modified appliance 100 (having the same lower portion as that of FIG. 3) with the plug 250 replaced by a UK-style plug 250a. The plugs 250 and 250a may be provided with a fixed connection to the cable 260, or using a disconnectable common plug connection. The UK-style plug 250a may be located with its tines extending into the space 230 and may optionally be secured therein with clips (not shown). Alternatively the space 230 may be large enough to entirely contain the UK-style plug 250a within it.

The cover 300, scoop 240, and tools 400 are preferably made out of dishwasher-safe, food-safe materials. The cover 300 and scoop 240 are preferably made of a plastic for ease of manufacture, and more preferably may be made of a transparent plastic so that their contents may be easily seen by the user. The tools 400 are preferably made of a relatively rigid metal, such as, for example, stainless steel, for providing strength so as to prevent damage during food processing using them.

As used herein, the term “removable attachment” (and similar terms such as “removably attachable”), as used in relation to an attachment between a first object and a second object, preferably connotes that the first object is attached to the second object and can be detached (and preferably re-attached, detached again, and so on, repetitively), and/or that the first object may be removed from the second object without damaging the first object or the second object; more preferably the term connotes that the first object may be re-attached to the second object without damaging the first object or the second object, and/or that the first object may be removed from (and optionally also re-attached to) the second object by hand and/or without the use of tools (e.g. screwdrivers, spanners, etc). Mechanisms such as a snap-fit, a bayonet attachment, and a hand-rotatable locking nut may be used in this regard.

“Food safe” in this context means any substance that does not shed substances harmful to human health in clinically significant quantities if ingested. For example, it should be BPA-free.

“Dishwasher safe” means that it should be physically and chemically stable during prolonged exposure to the conditions prevailing within a dishwasher machine. For example it should be able to withstand exposure to a mixture of water and a typical dishwasher substance (e.g., washing with Fairy™ or Finish™ dishwasher tablets and water, at temperatures of 82 degrees centigrade for as long as 8 hours without visibly degrading (e.g., cracking)).

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

The following lists a number of aspects:
1. A kitchen appliance having a main housing, a handle extending from the housing, and a storage space co-operatively defined between the handle and the housing, and at least one accessory, wherein the storage space includes one or more storage niches configured to releasably receive and secure the accessory of the kitchen appliance.
2. The kitchen appliance of aspect 1, wherein the accessory is releasably attachable to the kitchen appliance at a location other than within the storage niche, preferably wherein the location other than the storage niche is a drive-outlet and the accessory is a food processing tool.
3. The kitchen appliance of any preceding aspect, the accessories comprising keyed attachment features configured to be matingly received within the storage niches.
4. The kitchen appliance of aspect 3, wherein the keyed attachment features are further configured to act as driving features.
5. The kitchen appliance of any preceding aspect, wherein the appliance further comprises anti-rotation means configured to inhibit rotation of accessories received within the storage niches, and preferably to orient the accessories so as to enhance storage.
6. The kitchen appliance of any preceding aspect, wherein the storage space has an open end opposite to a closed end of the storage space, for enhancing access to the storage space.
7. The kitchen appliance of aspect 6 where the storage niches are located within the storage space opposite the open end.
8. The kitchen appliance of any preceding aspect wherein the at least one accessory comprises two or more accessories, and one of the two or more accessories is configured to locate into the storage niche and be releasably secured therein, and retain an other of the two or more accessories within the storage space.
9. The kitchen appliance of aspect 8, wherein the one of the two or more accessories is one or more food processing tools, and the other of the two or more accessories is a plug.
10. The kitchen appliance of aspect 9, wherein the one of the two or more accessories comprises two processing tools configured to co-operatively retain the plug in the storage space.
11. The kitchen appliance of any preceding aspect, further comprising a cover-element configured to be removably attachable to the main housing so as to enclose the storage space.
12. The kitchen appliance of aspect 11, wherein the cover-element comprises a handle and the cover-element is configured to render the appliance hand-carryable via the handle when attached to the main housing.
13. A kitchen appliance comprising a scoop removably-attachable to a main body of the kitchen appliance, wherein the removable scoop is configured to retain an additional element on the main body when attached to the main body.
14. The kitchen appliance of aspect 12, wherein the additional element is a cable wrapped on the main body.
15. The kitchen appliance of either one of aspects 12 or 13, wherein the scoop comprises a scoop-portion and a handle-portion extending therefrom, and wherein the handle portion is configured to retain the additional element on the main body.
16. A kitchen appliance comprising a removable support, wherein the removable support comprises a scoop.
17. A kitchen appliance comprising a housing enclosing a motor-unit, the housing comprising a first portion and a second portion, wherein the first portion is a scoop removably attachable to the second portion to co-operatively enclose the motor-unit thereby.
18. The kitchen appliance of aspect 16, wherein the first portion and the second portion co-operatively form a smooth, continuous housing surface.
19. The kitchen appliance of any one of aspects 16 and 17, wherein the first portion comprises a scoop-portion, preferably rounded, and a handle-portion.
20. The kitchen appliance of aspect 18, wherein the handle-portion retains an additional element on the main body.
21. The kitchen appliance of aspect 19 wherein the additional element is a cable.
22. The kitchen appliance of either one of aspects 19 and 20, wherein the handle portion is concealed within the housing.
23. The kitchen appliance of any one of aspects 19-22, wherein the first portion is configured to act as a support for the kitchen appliance.
24. A kitchen appliance comprising a cable-wrap, wherein the cable-wrap extends circumferentially around the kitchen appliance, and comprises a cable-wrap niche configured to receive a wrapped cable, wherein the cable-wrap niche comprises one or more air-inlets and one or more air-outlets for permitting the ingress and egress of cooling air, and wherein the air-inlets and air-outlets are located on opposing sides of the kitchen appliance.
25. The kitchen appliance of aspect 24, wherein the air-inlets and air-outlets are located at opposing ends of a major axis of the kitchen appliance.

1-25. (canceled)

26. A kitchen appliance comprising:
a main housing;
a handle extending from the main housing; and
a storage space defined between the main housing and the handle, preferably for storing an accessory of the kitchen appliance.

27. The kitchen appliance of claim 26, further comprising at least one accessory, preferably at least one food processing tool and/or a plug, wherein the at least one accessory is stored within the storage space, optionally wherein the storage space is configured to store the at least one accessory such that the at least one accessory does not exceed a footprint of the kitchen appliance.

28. The kitchen appliance of claim 26, wherein the storage space comprises at least one storage hole, preferably a blind hole, more preferably a niche.

29. The kitchen appliance of claim 28, further comprising one or more accessories, wherein each storage hole is configured to releasably receive and secure at least one of the one or more accessories of the kitchen appliance.

30. The kitchen appliance of claim 27, wherein the at least one accessory is releasably attachable to the kitchen appliance at a location other than the storage space, preferably wherein the location other than the storage space is a drive-outlet, and more preferably wherein the at least one accessory is a food processing tool.

31. The kitchen appliance of claim 28, further comprising one or more accessories, wherein each accessory comprises a keyed attachment feature that is matingly (or co-operatively) received within the at least one storage hole, preferably wherein the keyed attachment feature is configured to act as a driving feature.

32. The kitchen appliance of claim 29, wherein each storage hole comprises a means for inhibiting rotation of the at least one accessory received within each storage hole.

33. The kitchen appliance of claim 32, wherein there are at least two accessories, and the means orientates the accessories such that the accessories can be positioned within the storage space to be closer together than other orientations of the accessories.

34. The kitchen appliance of claim 26, wherein the storage space has an open end and a closed end, wherein the open end is opposite to the closed end of the storage space for enhancing access to the storage space, preferably wherein at least one storage hole is disposed on the closed end of the storage space.

35. The kitchen appliance of any of claim 29, wherein there are at least two accessories, and one of the at least two accessories is releasably secured within the storage hole and retains another of the at least two accessories within the storage space.

36. The kitchen appliance of claim 29, wherein there are at least two accessories, and the accessories are configured to co-operatively secure a plug of the kitchen appliance when the accessories are stored in the storage holes.

37. The kitchen appliance of claim 29, wherein the kitchen appliance further comprises an accessory ejector button configured to eject the at least one accessory from the at least one storage hole, preferably wherein the ejector button is further configured to eject the at least one accessory from a drive-outlet.

38. The kitchen appliance of claim 26, wherein the kitchen appliance further comprises a cover and the main housing comprises a base, wherein the cover is configured to enclose at least a portion of the kitchen appliance, preferably the storage space and/or a control button or one or more controls of the kitchen appliance, such that the cover forms a smooth continuous surface with the base, and the cover is removably attachable to the main housing, optionally wherein the cover comprises a handle and the cover is configured to render the kitchen appliance hand-carriable via the handle when attached to the main housing.

39. A kitchen appliance comprising a main housing and a cover, wherein the main housing further comprises a base and the cover is configured to enclose at least a portion of the kitchen appliance, preferably a control button or one or more controls of the kitchen appliance, such that the cover forms a smooth continuous surface with the base, and the cover is removably attachable to the main housing.

40. The kitchen appliance of claim 39, wherein the cover comprises a handle and the cover is configured to render the kitchen appliance hand-carriable via the handle when attached to the main housing.

41. A kitchen appliance according to claim 26, the kitchen appliance further comprising a scoop, wherein at least one of:
the scoop is removably attachable to the main housing of the kitchen appliance, and the scoop is configured to retain an additional element, preferably a cable, on the main housing when attached to the main housing;
the scoop is configured to act as a removeable support for the kitchen appliance; and
the kitchen appliance further comprises a motor unit, wherein the scoop is removably attachable to the main housing such that the scoop and the main housing co-operatively enclose the motor unit.

42. A kitchen appliance comprising a scoop, wherein at least one of:
the scoop is removably attachable to a main housing of the kitchen appliance, and the scoop is configured to retain an additional element, preferably a cable, on the main housing when attached to the main housing;
the scoop is configured to act as a removeable support for the kitchen appliance; and
the kitchen appliance further comprises a main housing and a motor unit, wherein the scoop is removably attachable to the main housing, such that the scoop and the housing co-operatively enclose the motor unit.

43. The kitchen appliance of claim 42, wherein the scoop comprises a scoop portion and a handle portion, preferably wherein the scoop portion is rounded and the handle portion retains the additional element, optionally wherein when the scoop is attached to the main housing such that the scoop and the main housing co-operatively form a smooth continuous surface, and/or wherein the handle portion is concealed within the main housing.

44. The kitchen appliance of claim 26, comprising a cable and a cable wrap recess, preferably a cable wrap niche, wherein the cable wrap recess extends circumferentially around, preferably approximately a major axis and/or a widest part of, the kitchen appliance, preferably approximately parallel to a surface on which the kitchen appliance is to be placed, and is configured to receive the cable.

45. The kitchen appliance of claim 44, wherein the cable wrap recess comprises one or more air inlets and one or more air outlets allowing for the ingress and egress of cooling air, preferably the one or more air inlets and air outlets are disposed on opposing ends of approximately a major axis of the kitchen appliance.
